(19) United States
(12) Patent Application Publication
(10) Pub. No.: US 2026/0353510 A1
(43) Pub. Date: Nov. 5, 2026

(54) BLACKHOLE PREVENTION

(71) Applicant: Juniper Networks, Inc., Sunnyvale, CA (US)

(72) Inventors: Santosh Popat Rokade, San Jose, CA (US); Wesley Purvis, Yardley, PA (US); Posen Hung, San Jose, CA (US); Satish Jain, San Jose, CA (US)

(21) Appl. No.: 19/558,216

(22) Filed: Mar. 5, 2026

Related U.S. Application Data
(60) Provisional application No. 63/797,412, filed on Apr. 30, 2025.

(51) Int. Cl. H04W 76/32; H04L 12/46

(52) U.S. Cl. CPC H04W 76/32; H04L 12/4633; H04L 12/4641

(57) ABSTRACT

Techniques are described for a network device to determine that network connectivity associated with a virtual local area network (VLAN) is down and disable access to one or more wireless local area networks (WLANs) that are associated with the VLAN. For instance, based on configuration information of the APs and switches, an AP may generate a mapping of one or more WLANs associated with one or more VLANs and a mapping of the one or more VLANs associated with one or more tunneling sessions. The AP may determine that one or more tunneling sessions are down. The AP may assign an identifier identifying the one or more VLANs that are associated with the down tunneling sessions and disable access to one or more WLANs associated with the labeled VLANs. In this way, client devices are unable to access WLANs associated with VLANs that are having issues, thus preventing blackholes.

### CROSS REFERENCE

This application claims the benefit of US Provisional Patent Application No. 63/797,412, filed 30 Apr. 2025, the entire contents of which is incorporated herein by reference.

### TECHNICAL FIELD

The disclosure relates generally to computer networks and, more specifically, to monitoring and troubleshooting network connectivity within computer networks.

### BACKGROUND

Commercial premises or sites, such as offices, hospitals, airports, stadiums, or retail outlets, often install complex wireless network systems, including a network of wireless access points (APs), throughout the premises to provide wireless network services, to one or more wireless client devices (or simply, “clients”). APs are physical, electronic devices that enable other devices to wirelessly connect to a wired network using various wireless networking protocols and technologies, such as wireless local area networking (WLAN) protocols conforming to one or more of the IEEE 802.11 standards (i.e., “WiFi”), Bluetooth / Bluetooth Low Energy (BLE), mesh networking protocols such as ZigBee or other wireless networking technologies. Many different types of wireless client devices, such as laptop computers, smartphones, tablets, wearable devices, appliances, and Internet of Things (IoT) devices, incorporate wireless communication technology and can be configured to connect to wireless access points when the device is in range of a compatible wireless access point in order to access a wired network.

In some examples, a WLAN may be associated with one or more virtual local area networks (VLANs). A VLAN may be established to manage and segment network traffic so that clients of a WLAN may receive specific network access and services and be logically isolated from clients associated with different VLANs. For a WLAN to provide wireless network services to clients, APs of a WLAN may map the WLAN to a VLAN identifier associated with a VLAN and may tag network traffic with the VLAN identifier associated with the VLAN and forward the network traffic with the tagged VLAN identifier to a network device which may route the network traffic based on the VLAN identifier.

### BRIEF DESCRIPTION OF DRAWINGS

FIG. 1A is a block diagram of an example network system, in accordance with one or more techniques of the disclosure.

FIG. 1B is a block diagram illustrating further example details of the network system of FIG. 1A.

FIG. 2A is a block diagram of an example access point device, in accordance with one or more techniques of this disclosure.

FIG. 2B is a block diagram illustrating further details of a blackhole prevention engine of the access point device of FIG. 2A, in accordance with one or more techniques of this disclosure.

FIG. 3 is a block diagram of an example network management system, in accordance with one or more techniques of the disclosure.

FIG. 4 is a block diagram of an example user equipment device, in accordance with one or more techniques of this disclosure.

FIG. 5 is a block diagram of an example network node, such as a router or switch, in accordance with one or more techniques of this disclosure.

FIG. 6 illustrates an example operation of blackhole prevention, in accordance with one or more techniques of the disclosure.

FIG. 7 illustrates another example operation of blackhole prevention, in accordance with one or more techniques of the disclosure.

FIG. 8 is a flow chart illustrating an example operation of blackhole prevention, in accordance with one or more techniques of this disclosure.

### DETAILED DESCRIPTION

In general, this disclosure describes one or more techniques for an access point (AP) to determine that network connectivity associated with a virtual local area network (VLAN) is down and disable access to one or more wireless local area networks (WLANs) that are associated with the VLAN. In some examples, an AP may enable one or more clients to connect to a wired network via one or more WLANs. For a given WLAN, one or more VLANs may be configured to logically isolate network traffic communicated via the WLAN. For example, network traffic of clients associated with a first VLAN may be isolated from network traffic of clients associated with a second VLAN, such that clients associated with the first VLAN may not access network traffic of clients associated with the second VLAN and vice versa. In some examples, one or more tunneling sessions (e.g., Layer 2 Tunnel Protocol (L2TP) sessions) may be established to tunnel network traffic through a wide area network (WAN) for a corresponding VLAN through the tunneling sessions.

In some instances, clients connected to a WLAN may experience issues in communicating network traffic to a destination (e.g., a remote server) due to an issue with a VLAN associated with the WLAN or an issue with one or more tunneling sessions associated with the VLAN. In some examples, the VLAN may be misconfigured (e.g., VLAN mismatch, duplex mismatch, missing VLANs, port misconfiguration, etc.), a tunneling session for the VLAN may be misconfigured (e.g., misconfiguring certificate and/or security keys, etc.), and/or there is a physical connectivity issue (e.g., physical connectivity issue between AP to the wired network or a physical connectivity issue between endpoints of a tunneling session, etc.). In these instances, APs typically, despite one or more issues with the VLAN or tunneling session for the VLAN, continue to provide clients with access to a WLAN associated with the VLAN, such that clients may still connect or remain connected to the WLAN and continue to send network traffic via the WLAN. However, due to network connectivity associated with the VLAN being down, for example, because the VLAN or tunneling session for the VLAN is having issues, network traffic communicated via the WLAN will eventually, and unknowingly to the clients, be dropped (otherwise referred to as a “blackhole”).

In accordance with one or more aspects of this disclosure, an AP may determine that network connectivity associated with a VLAN is down and disable access to the one or more WLANs that are associated with the VLAN. For instance, based on configuration information of the APs and switches, an AP may generate a mapping of one or more WLANs associated with one or more VLANs and a mapping of the one or more VLANs associated with one or more tunneling sessions. The AP may determine that one or more tunneling sessions are down, for example, by determining a number of active tunneling sessions does not match (e.g., is less than) a number of configured tunneling sessions. The AP may assign a label or other identifier identifying the one or more VLANs that are associated with the down tunneling sessions and disable access to one or more WLANs associated with the labeled VLANs. In this way, client devices are unable to access WLANs associated with VLANs that are having issues, thus preventing blackholes to reduce loss of network traffic, client confusion, and client dissatisfaction.

The details of one or more examples of the techniques of this disclosure are set forth in the accompanying drawings and the description below. Other features, objects, and advantages of the techniques will be apparent from the description and drawings, and from the claims.

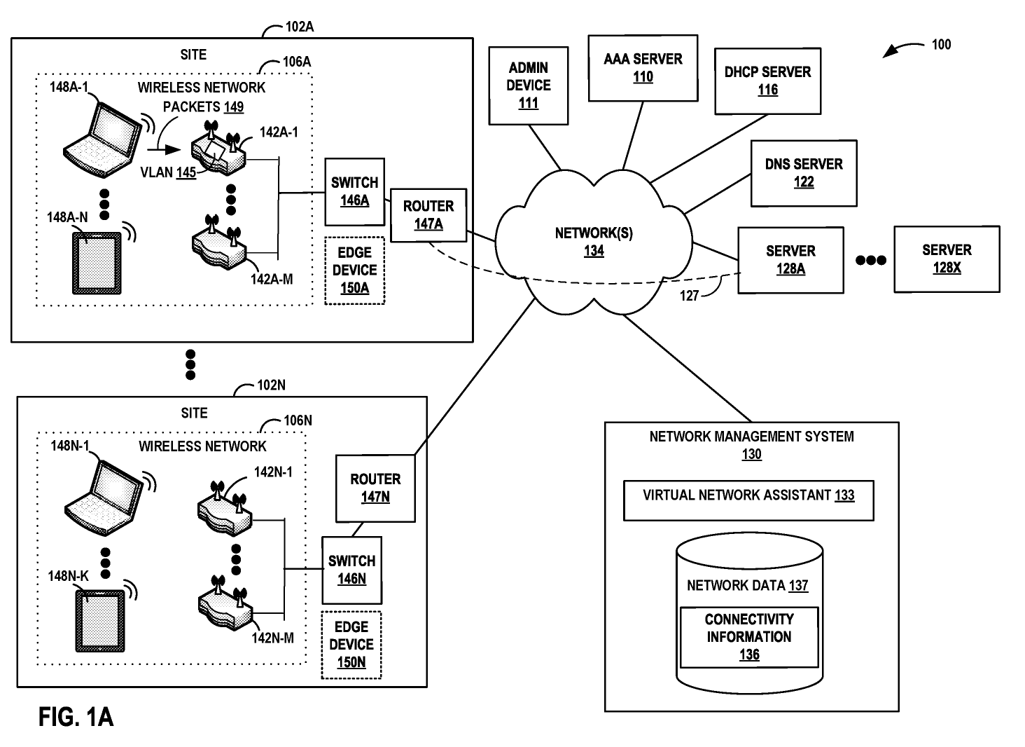

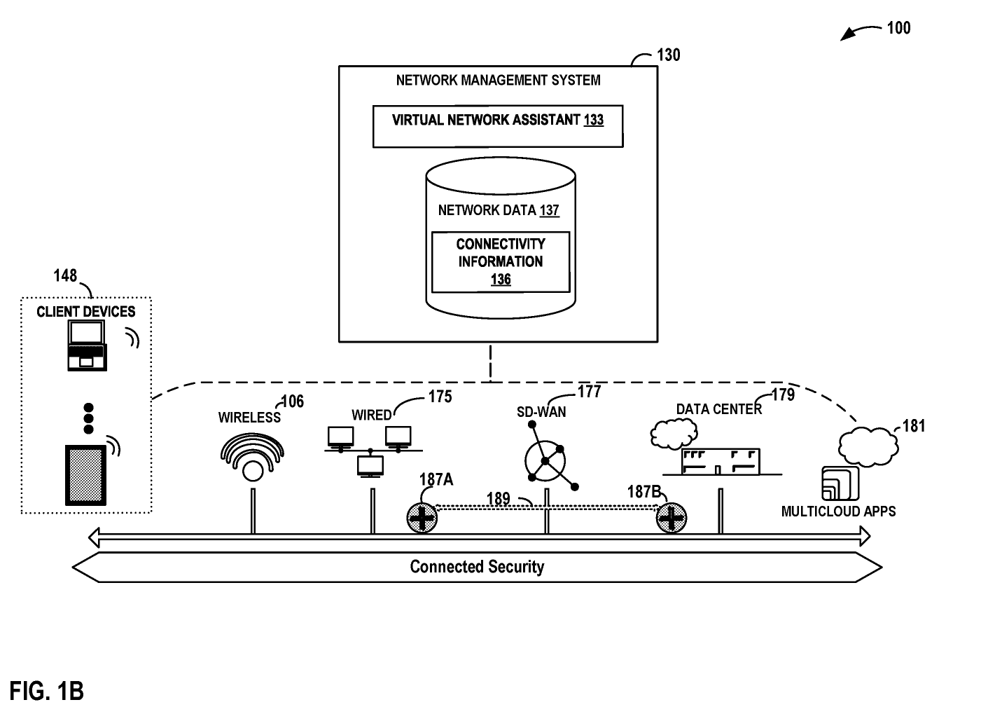

FIG. 1A is a block diagram of an example network system 100 including network management system (NMS) 130, in accordance with one or more techniques of this disclosure. Example network system 100 includes a plurality of sites 102A-102N at which a network service provider manages one or more wireless networks 106A-106N (herein, “WLANs 106”), respectively. Although in FIG. 1A each site 102A-102N is shown as including a single wireless network 106A-106N, respectively, in some examples, each site 102A-102N may include multiple wireless networks, and the disclosure is not limited in this respect.

Each site 102A-102N includes a plurality of network access server (NAS) devices, such as access points (APs) 142, switches 146, or routers 147. For example, site 102A includes a plurality of APs 142A-1-142A-M. Similarly, site 102N includes a plurality of APs 142N-1-142N-M. Each AP 142 may be any type of wireless access point, including, but not limited to, a commercial or enterprise AP, a router, or any other device that is connected to a wired network and is capable of providing wireless network access to client devices within the site.

Each site 102A-102N also includes a plurality of client devices, otherwise known as user equipment devices (UEs), referred to generally as UEs or client devices 148, representing various wireless-enabled devices within each site. For example, a plurality of UEs 148A-1-148A-K are currently located at site 102A. Similarly, a plurality of UEs 148N-1-148N-K are currently located at site 102N. Each UE 148 may be any type of wireless client device, including, but not limited to, a mobile device such as a smart phone, tablet or laptop computer, a personal digital assistant (PDA), a wireless terminal, a smart watch, smart ring, or other wearable device. UEs 148 may also include wired client-side devices, e.g., IoT devices such as printers, security devices, environmental sensors, or any other device connected to the wired network and configured to communicate over one or more wireless networks 106.

In order to provide wireless network services to UEs 148 and/or communicate over the wireless networks 106, APs 142 and the other wired client-side devices at sites 102 are connected, either directly or indirectly, to one or more network devices (e.g., switches, routers, gateways, or the like) via physical cables, e.g., Ethernet cables. In the example of FIG. 1A, site 102A includes switch 146A and router 147A. In one example, one or more of routers 147 may be a gateway device. Each of APs 142A-1 through 142A-M at site 102A are connected to switch 146A which is connected to router 147A. Similarly, site 102N includes switch 146N and router 147N. Each of APs 142N-1 through 142N-M at site 102N are connected to switch 146N which is connected to router 147N. Although illustrated in FIG. 1A as if each site 102 includes a single switch 146 and all APs 142 of the given site 102 are connected to the single switch 146, in other examples, each site 102 may include more or fewer switches, and/or routers. In addition, the APs and the other wired client-side devices of the given site may be connected to two or more switches and/or routers. In addition, two or more switches at a site may be connected to each other and/or connected to two or more routers, e.g., via a mesh or partial mesh topology in a hub-and-spoke architecture. In some examples, interconnected switches, and routers comprise wired local area networks (LANs) at sites 102 hosting wireless networks 106.

Example network system 100 also includes various networking components for providing networking services within the wired network including, as examples, an Authentication, Authorization and Accounting (AAA) server 110 for authenticating users and/or UEs 148, a Dynamic Host Configuration Protocol (DHCP) server 116 for dynamically assigning network addresses (e.g., IP addresses) to UEs 148 upon authentication, a Domain Name System (DNS) server 122 for resolving domain names into network addresses, a plurality of servers 128A-128X (collectively “servers 128”) (e.g., web servers, databases servers, file servers and the like), and a network management system (NMS) 130. As shown in FIG. 1A, the various devices and systems of network 100 are coupled together via one or more network(s) 134, e.g., the Internet and/or an enterprise intranet.

In the example of FIG. 1A, NMS 130 is a cloud-based computing platform that manages wireless networks 106A-106N at one or more of sites 102A-102N. As further described herein, NMS 130 provides an integrated suite of management tools and implements various techniques of this disclosure. In general, NMS 130 may provide a cloud-based platform for wireless network data acquisition, monitoring, activity logging, reporting, predictive analytics, network anomaly identification, and alert generation. In some examples, NMS 130 outputs notifications, such as alerts, alarms, graphical indicators on dashboards, log messages, text / SMS messages, email messages, and the like, and/or recommendations regarding wireless network issues to a site or network administrator (“admin”) interacting with and/or operating admin device 111. Additionally, in some examples, NMS 130 operates in response to configuration input received from the administrator interacting with and/or operating admin device 111.

The administrator and admin device 111 may comprise IT personnel and an administrator computing device associated with one or more of sites 102. Admin device 111 may be implemented as any suitable device for presenting output and/or accepting user input. For instance, admin device 111 may include a display. Admin device 111 may be a computing system, such as a mobile or non-mobile computing device operated by a user and/or by the administrator. Admin device 111 may, for example, represent a workstation, a laptop or notebook computer, a desktop computer, a tablet computer, or any other computing device that may be operated by a user and/or present a user interface in accordance with one or more aspects of the present disclosure. Admin device 111 may be physically separate from and/or in a different location than NMS 130 such that admin device 111 may communicate with NMS 130 via network 134 or other means of communication.

In some examples, one or more of the NAS devices, e.g., APs 142, switches 146, or routers 147, may connect to edge devices 150A-150N via physical cables, e.g., Ethernet cables. Edge devices 150 comprise cloud-managed, wireless local area network (LAN) controllers. Each of edge devices 150 may comprise an on-premises device at a site 102 that is in communication with NMS 130 to extend certain microservices from NMS 130 to the on-premises NAS devices while using NMS 130 and its distributed software architecture for scalable and resilient operations, management, troubleshooting, and analytics.

Each one of the network devices of network system 100, e.g., servers 110, 116, 122 and/or 128, APs 142, UEs 148, switches 146, routers 147, and any other servers or devices attached to or forming part of network system 100, may include a system log or an error log module wherein each one of these network devices records the status of the network device including normal operational status and error conditions. Throughout this disclosure, one or more of the network devices of network system 100, e.g., servers 110, 116, 122 and/or 128, APs 142, UEs 148, routers 147, and switches 146, may be considered “third-party” network devices when owned by and/or associated with a different entity than NMS 130 such that NMS 130 does not receive, collect, or otherwise have access to the recorded status and other data of the third-party network devices. In some examples, edge devices 150 may provide a proxy through which the recorded status and other data of the third-party network devices may be reported to NMS 130.

In some examples, NMS 130 monitors network data 137, e.g., one or more service level expectation (SLE) metrics, received from wireless networks 106A-106N at each site 102A-102N, respectively. Network data 137 may include connectivity information 136 associated with, for example, network connectivity between one or more client devices and/or endpoints, (e.g., information associated with client device 148A-1 and server 128A). For example, connectivity information 136 may include information specifying a number of active tunneling sessions, a number of configured tunneling sessions, configuration information of a logical connection of NAS devices, a state of a physical or logical connection, or any other information associated with a connection with or through a NAS device.

NMS 130 may manage network resources, such as APs 142 at each site, to deliver a high-quality wireless experience to end users, IoT devices and clients at the site. For example, NMS 130 may include a virtual network assistant (VNA) 133 that implements an event processing platform for providing real-time insights and simplified troubleshooting for IT operations, and that automatically takes corrective action or provides recommendations to proactively address wireless network issues. VNA 133 may, for example, include an event processing platform configured to process hundreds or thousands of concurrent streams of network data 137 from sensors and/or agents associated with APs 142 and/or nodes within network 134. For example, VNA 133 of NMS 130 may include an underlying analytics and network error identification engine and alerting system in accordance with various examples described herein. The underlying analytics engine of VNA 133 may apply historical data and models to the inbound event streams to compute assertions, such as identified anomalies or predicted occurrences of events constituting network error conditions. Further, VNA 133 may provide real-time alerting and reporting to notify a site or network administrator via admin device 111 of any predicted events, anomalies, trends, and may perform root cause analysis and automated or assisted error remediation. In some examples, VNA 133 of NMS 130 may apply machine learning techniques to identify the root cause of error conditions detected or predicted from the streams of network data 137. If the root cause may be automatically resolved, VNA 133 may invoke one or more corrective actions to correct the root cause of the error condition, thus automatically improving the underlying SLE metrics and also automatically improving the user experience.

Further example details of operations implemented by the VNA 133 of NMS 130 are described in U.S. Patent No. 9,832,082, issued Nov. 28, 2017, and entitled “Monitoring Wireless Access Point Events,” U.S. Publication No. US 2021/0306201, published Sep. 30, 2021, and entitled “Network System Fault Resolution Using a Machine Learning Model,” U.S. Patent No. 10,985,969, issued Apr. 20, 2021, and entitled “Systems and Methods for a Virtual Network Assistant,” U.S. Patent No. 10,958,585, issued Mar. 23, 2021, and entitled “Methods and Apparatus for Facilitating Fault Detection and/or Predictive Fault Detection,” U.S. Patent No. 10,958,537, issued Mar. 23, 2021, and entitled “Method for Spatio-Temporal Modeling,” and U.S. Patent No. 10,862,742, issued Dec. 8, 2020, and entitled “Method for Conveying AP Error Codes Over BLE Advertisements,” all of which are incorporated herein by reference in their entirety.

In operation, NMS 130 observes, collects and/or receives network data 137, which may take the form of data extracted from messages, counters, and statistics, for example. In accordance with one specific implementation, a computing device is part of NMS 130. In accordance with other implementations, NMS 130 may comprise one or more computing devices, dedicated servers, virtual machines, containers, services, or other forms of environments for performing the techniques described herein. Similarly, computational resources and components implementing VNA 133 may be part of the NMS 130, may execute on other servers or execution environments, or may be distributed to nodes within network 134 (e.g., routers, switches, controllers, gateways, and the like).

Each of APs 142 may enable one or more client devices 148 to connect to a wired network via one or more WLANs 106. Each of WLAN 106 may be associated with one or more virtual local area networks (VLANs). Client devices 148 may connect to WLAN 106 and send network traffic that gets tagged (e.g., with a VLAN identifier) by an AP 142 to process the network traffic to the correct VLAN. In this way, the one or more VLANs associated with one or more WLANs 106 may be configured to logically isolate network traffic communicated via WLANs 106. For example, AP 142A-1 may map a Service Set Identifier (SSID) of WLAN 106A to a VLAN identifier of a first VLAN (e.g., VLAN 145) and may tag network traffic of client device 148A-1 associated with the first VLAN to isolate the network traffic, for example, from network traffic associated with a second VLAN, such that the network traffic of each VLAN is logically separated.

In some examples, one or more tunneling sessions may be established to tunnel network traffic for a corresponding VLAN through a wide area network (e.g., network 134) via the tunneling sessions. For example, a router, such as router 147A, may establish a tunneling session with a remote endpoint (e.g., a remote router for server 128A) to forward network traffic for the corresponding VLAN. Tunneling may provide a private, secure path through an otherwise public network. Tunnels may connect discontinuous subnetworks and enable encryption interfaces, virtual private networks, etc. In some examples, a tunneling session may include an L2TP session for tunneling Layer 2 traffic over a Layer 3 network (e.g., network 134). A tunneling session may additionally, or alternatively, include a Point-to-Point Tunneling Protocol (PPTP) session, a Generic Routing Encapsulation (GRE) tunneling session, a Multiprotocol Label Switching (MPLS) tunneling session. In some examples, router 147A may alternatively, or additionally, use a stateful session-based routing scheme that eschews the use of tunnels to forward traffic to the remote endpoint, as further described in FIG. 1B. While the examples described above are described with respect to a router establishing a tunneling session, in other examples a switch (e.g., switch 146) configured to perform both layer 2 switching and layer 3 routing functions may establish the one or more tunneling sessions for routing network traffic of a corresponding VLAN.

As one example, client device 148A-1 may connect to WLAN 106A via AP 142A-1, and may send network traffic, e.g., one or more packets 149, destined for server 128A to AP 142A-1. AP 142A-1 may tag the packet from client device 148A-1 with a VLAN identifier associated with VLAN 145 and forward the network traffic with the tagged VLAN identifier to switch 146A, which may route the network traffic based on the VLAN identifier. For example, switch 146A may send the network traffic with the tagged VLAN identifier to router 147A, which may tunnel the network traffic with the tagged VLAN identifier through network 134 via a tunneling session 127.

In some instances, client device 148A-1 connected to WLAN 106A may experience issues in communicating network traffic to a remote endpoint (e.g., server 128) due to an issue with network connectivity associated with VLAN 145 associated with WLAN 106A. In some examples, VLAN 145 associated with WLAN 106A may be misconfigured (e.g., VLAN mismatch, duplex mismatch, missing VLANs, port misconfiguration, etc.) and cause packets 149 associated with VLAN 145 to be dropped. In some examples, one or more physical connectivity issues at site 102A (e.g., between AP 142A-1 and switch 146A, between switch 146A and router 147A, etc.) may cause packets 149 associated with VLAN 145 to be dropped. In some examples, tunneling session 127 for VLAN 145 may be misconfigured (e.g., misconfiguring certificate and/or security keys, etc.) and may cause packets 149 associated with VLAN 145 to be dropped.

In these instances, AP 142A-1 may, without the techniques described in this disclosure, continue to provide client device 148A-1 and/or other client devices 148 with access to WLAN 106A associated with VLAN 145 despite one or more network connectivity issues associated with VLAN 145. Client device 148A-1 may still connect or remain connected to WLAN 106A and continue to send network traffic via WLAN 106A. However, due to network connectivity associated with VLAN 145 being down, network traffic communicated via WLAN 106A (e.g., packets 149) will eventually, and unknowingly to the client operating client device 148A-1, be dropped (otherwise referred to as a “blackhole”).

In accordance with one or more aspects of this disclosure, one or more of APs 142 may determine that network connectivity associated with a VLAN is down and disable access to one or more WLANs 106 that are associated with the VLAN. Network connectivity associated with a VLAN may be considered “down” when a client device is unable to send network traffic to a desired endpoint due to an issue associated with the VLAN. As one example, based on configuration information of AP 142A-1 and/or switch 146A, AP 142A-1 may generate a WLAN-to-VLAN mapping and a VLAN-to-tunnel mapping. In this example, AP 142A-1 may generate a WLAN-to-VLAN mapping that specifies a mapping of WLAN 106A with VLAN 145 and a VLAN-to-tunnel mapping that specifies a mapping of VLAN 145 with tunneling session 127. For example, AP 142A-1 may generate a mapping of a service set identifier (SSID) of WLAN 106A to a VLAN identifier of VLAN 145, and may generate a mapping of the VLAN identifier of VLAN 145 to a session identifier of tunneling session 127. As further described below, AP 142A-1 may determine that tunneling session 127 is down, for example, by determining a number of active tunneling sessions (e.g., 0) does not match (e.g., is less than) a number of configured tunneling sessions (e.g., 1). Based on determining that tunneling session 127 is down, AP 142A-1 may determine that VLAN 145 is associated with tunneling session 127 based on the VLAN-to-tunnel mapping. AP 142A-1 may assign a label or other identifier to VLAN 145 to indicate VLAN 145 is down. AP 142A-1 may further determine that WLAN 106A is associated with VLAN 145 based on the WLAN-to-VLAN mapping and may assign a label or other identifier to WLAN 106A to indicate WLAN 106A is affected by tunneling session 127 being down. AP 142A-1 may then disable access to WLAN 106A based on the label or other identifier assigned to WLAN 106A.

In some examples, AP 142A-1 may determine that there is an issue with a connection to router 147A. For example, AP 142A-1 may determine that the connection to router 147A has an issue based on determining that AP 142A-1 is missing an IP address of router 147A. In this example, AP 142A-1 may disable access to WLAN 106A. In some examples, AP 142A-1 may additionally, or alternatively, obtain connectivity information 136 from NMS 130 and determine, based on the connectivity information 136 from NMS 130, that network connectivity associated with VLAN 145 is down. The examples described above are merely examples of instances in which AP 142A-1 determines an issue with a network connectivity associated with a VLAN and disables access to a WLAN associated with the VLAN. AP 142A-1 may determine an issue with a network connectivity associated with a VLAN based on other information, such as determining that there is an issue with VLAN 145 based on the configuration of VLAN 145 and/or network data indicative of the performance of network traffic associated with VLAN 145. In this way, client devices are inhibited from accessing WLAN 106A which may prevent client devices from forwarding network traffic, associated with a VLAN having an issue, into WLAN 106A, thus preventing blackholes and reducing the loss of network traffic, client confusion, and client dissatisfaction.

Although the techniques of the present disclosure are described in this example as performed by one or more of APs 142, techniques described herein may be performed by any other computing device(s), system(s), and/or server(s), and that the disclosure is not limited in this respect. For example, one or more computing device(s) configured to execute the functionality of the techniques of this disclosure may reside in and be operated by NMS 130. In another example, one or more computing device(s) configured to execute the functionality of the techniques of this disclosure may reside in a dedicated server or be included in any other server or may be distributed throughout network 100.

FIG. 1B is a block diagram illustrating further example details of the network system of FIG. 1A. In this example, FIG. 1B illustrates NMS 130 configured to operate according to an artificial intelligence / machine-learning-based computing platform providing comprehensive automation, insight, and assurance (WiFi Assurance, Wired Assurance and WAN assurance) spanning from “client,” e.g., user devices 148 connected to wireless network 106 and wired LAN 175 (far left of FIG. 1B), to “cloud,” e.g., cloud-based application services 181 that may be hosted by computing resources within data centers 179 (far right of FIG. 1B).

While aspects of the disclosure are primarily described as being performed by one or more of APs 142, NMS 130 provides an integrated suite of management tools and may implement aspects of the disclosure. In general, NMS 130 may provide a cloud-based platform for wireless network data acquisition, monitoring, activity logging, reporting, predictive analytics, network anomaly identification, and alert generation. For example, network management system 130 may be configured to proactively monitor and adaptively configure network 100 so as to provide self-driving capabilities. Moreover, VNA 133 includes a natural language processing engine to provide AI-driven support and troubleshooting, anomaly detection, AI-driven location services, and AI-driven radio frequency (RF) optimization with reinforcement learning.

As illustrated in the example of FIG. 1B, AI-driven NMS 130 also provides configuration management, monitoring and automated oversight of software defined wide-area network (SD-WAN) 177, which operates as an intermediate network communicatively coupling wireless networks 106 and wired LANs 175 to data centers 179 and application services 181. In general, SD-WAN 177 provides seamless, secure, traffic-engineered connectivity between “spoke” routers 187A of wired networks 175 hosting wireless networks 106, such as branch or campus networks, to “hub” routers 187B further up the cloud stack toward cloud-based application services 181. SD-WAN 177 often operates and manages an overlay network on an underlying physical Wide-Area Network (WAN), which provides connectivity to geographically separate customer networks. In other words, SD-WAN 177 extends Software-Defined Networking (SDN) capabilities to a WAN and allows network(s) to decouple underlying physical network infrastructure from virtualized network infrastructure and applications such that the networks may be configured and managed in a flexible and scalable manner.

In some examples, underlying routers of SD-WAN 177 may implement a stateful, session-based routing scheme in which the routers 187A, 187B dynamically modify contents of original packet headers sourced by client devices 148 to steer traffic along selected paths toward application services 181 without requiring use of tunnels and/or additional labels. In this way, routers 187A, 187B may be more efficient and scalable for large networks since the use of tunnel-less, session-based routing may enable routers 187A, 187B to achieve considerable network resources by obviating the need to perform encapsulation and decapsulation at tunnel endpoints. Moreover, in some examples, each router 187A, 187B may independently perform path selection and traffic engineering to control packet flows associated with each session without requiring use of a centralized SDN controller for path selection and label distribution. In some examples, routers 187A, 187B implement session-based routing as Secure Vector Routing (SVR), provided by Juniper Networks, Inc.

Additional information with respect to session-based routing and SVR is described in U.S. Patent No. 9,729,439, entitled “COMPUTER NETWORK PACKET FLOW CONTROLLER,” and issued on Aug. 8, 2017; U.S. Patent No. 9,729,682, entitled “NETWORK DEVICE AND METHOD FOR PROCESSING A SESSION USING A PACKET SIGNATURE,” and issued on Aug. 8, 2017; U.S. Patent No. 9,762,485, entitled “NETWORK PACKET FLOW CONTROLLER WITH EXTENDED SESSION MANAGEMENT,” and issued on Sept. 12, 2017; U.S. Patent No. 9,871,748, entitled “ROUTER WITH OPTIMIZED STATISTICAL FUNCTIONALITY,” and issued on Jan. 16, 2018; U.S. Patent No. 9,985,883, entitled “NAME-BASED ROUTING SYSTEM AND METHOD,” and issued on May 29, 2018; U.S. Patent No. 10,200,264, entitled “LINK STATUS MONITORING BASED ON PACKET LOSS DETECTION,” and issued on Feb. 5, 2019; U.S. Patent No. 10,277,506, entitled “STATEFUL LOAD BALANCING IN A STATELESS NETWORK,” and issued on Apr. 30, 2019; U.S. Patent No. 10,432,522, entitled “NETWORK PACKET FLOW CONTROLLER WITH EXTENDED SESSION MANAGEMENT,” and issued on Oct. 1, 2019; and U.S. Patent No. 11,075,824, entitled “IN-LINE PERFORMANCE MONITORING,” and issued on Jul. 27, 2021, the entire content of each of which is incorporated herein by reference in its entirety.

In some examples, routers 187 may implement a tunneling session 189, e.g., an L2TP tunneling session, to tunnel network traffic in a layer 2 network (e.g., network in WLAN 106 and wired network 175) over a layer 3 network (e.g., SD-WAN 177). For example, router 187A may configure tunneling session 189 and may send network traffic tagged by an AP in WLAN 106 over SD-WAN 177 via tunneling session 189.

In some examples, AI-driven NMS 130 may enable intent-based configuration and management of network system 100, including enabling construction, presentation, and execution of intent-driven workflows for configuring and managing devices associated with wireless networks 106, wired LAN networks 175, and /or SD-WAN 177. For example, declarative requirements express a desired configuration of network components without specifying an exact native device configuration and control flow. By utilizing declarative requirements, what should be accomplished may be specified rather than how it should be accomplished. Declarative requirements may be contrasted with imperative instructions that describe the exact device configuration syntax and control flow to achieve the configuration. By utilizing declarative requirements rather than imperative instructions, a user and/or user system is relieved of the burden of determining the exact device configurations required to achieve a desired result of the user/system. For example, it is often difficult and burdensome to specify and manage exact imperative instructions to configure each device of a network when various different types of devices from different vendors are utilized. The types and kinds of devices of the network may dynamically change as new devices are added and device failures occur. Managing various different types of devices from different vendors with different configuration protocols, syntax, and software versions to configure a cohesive network of devices is often difficult to achieve. Thus, by only requiring a user/system to specify declarative requirements that specify a desired result applicable across various different types of devices, management and configuration of the network devices becomes more efficient. Further example details and techniques of an intent-based network management system are described in U.S. Patent No. 10,756,983, entitled “Intent-based Analytics,” and U.S. Patent No. 10,992,543, entitled “Automatically generating an intent-based network model of an existing computer network,” each of which is hereby incorporated by reference.

In accordance with one or more aspects of this disclosure, one or more of APs 142 may determine that network connectivity associated with a VLAN is down and disable access to one or more WLANs 106 that are associated with the VLAN. The network connectivity associated with a VLAN may include connectivity with or through a device in WLAN 106, wired network 175 and/or SD-WAN 177. In some examples, an AP 142 may determine that network connectivity associated with a VLAN is down based on its own measurements or based on connectivity information 136 from NMS 130, such as information specifying a number of active tunneling sessions and/or a number of configured tunneling sessions in SD-WAN 177, configuration information of a logical connection of NAS devices, a state of a physical or logical connection, or any other information associated with a connection with or through a NAS device in WLAN 106 and/or wired network 175. In some examples, an AP 142 may determine that network connectivity associated with a VLAN is down based on connectivity information determined by AP 142. Based on determining that network connectivity associated with a VLAN is down, the AP 142 may disable access to WLAN 106.

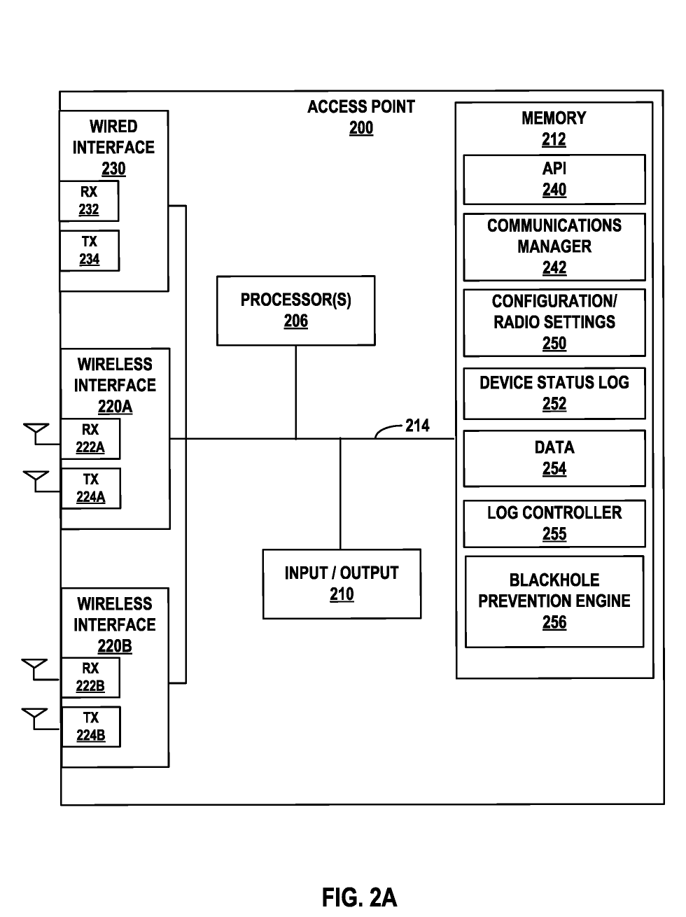

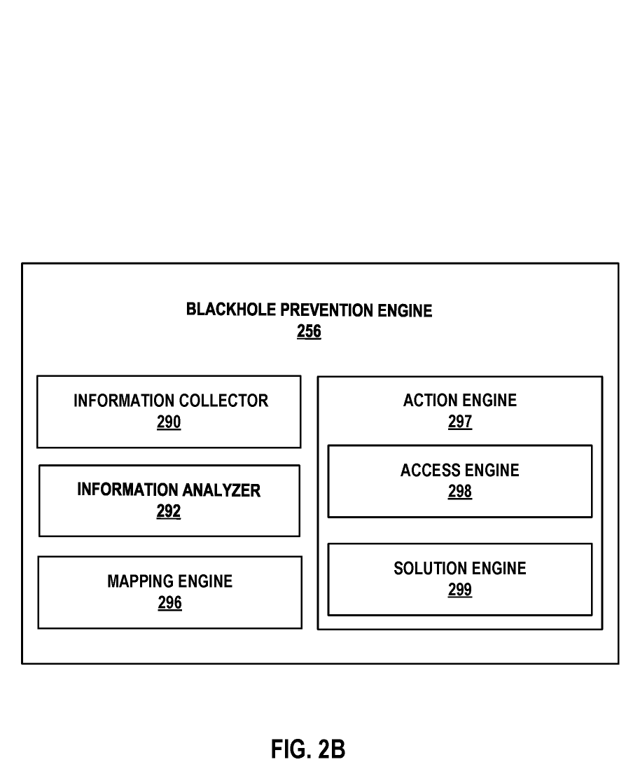

FIG. 2A is a block diagram of an example access point (AP) device 200, in accordance with one or more techniques of this disclosure. Example access point 200 shown in FIG. 2A may be an example of AP 142A-1 as shown and described in FIG. 1A, but may represent any of APs 142 in FIG. 1A. Access point 200 may comprise, for example, a Wi-Fi, Bluetooth and/or Bluetooth Low Energy (BLE) base station or any other type of wireless access point.

In the example of FIG. 2A, access point 200 includes a wired interface 230, wireless interfaces 220A-220B one or more processor(s) 206, memory 212, and input/output 210, coupled together via a bus 214 over which the various elements may exchange data and information. Wired interface 230 represents a physical network interface and includes a receiver 232 and a transmitter 234 for sending and receiving network communications, e.g., packets. Wired interface 230 couples, either directly or indirectly, access point 200 to a wired network device, such as one of switches 146 of FIG. 1A, within the wired network via a cable, such as an Ethernet cable.

First and second wireless interfaces 220A and 220B represent wireless network interfaces and include receivers 222A and 222B, respectively, each including a receive antenna via which access point 200 may receive wireless signals from wireless communications devices, such as UEs 148 of FIG. 1A. First and second wireless interfaces 220A and 220B further include transmitters 224A and 224B, respectively, each including transmit antennas via which access point 200 may transmit wireless signals to wireless communications devices, such as UEs 148 of FIG. 1A. In some examples, first wireless interface 220A may include a Wi-Fi 802.11 interface (e.g., 2.4 GHz and/or 5 GHz) and second wireless interface 220B may include a Bluetooth interface and/or a Bluetooth Low Energy (BLE) interface. In some examples, first and/or second wireless interfaces 220A and 220B may alternatively include an ultra-wide band (UWB) wireless interface or may be included in another wireless interface (not shown) of AP device 200. In these examples, first wireless interface 220A may include a UWB wireless transmitter and a UWB wireless receiver. The example described above is given for example purposes only, and the disclosure is not limited in this respect.

Processor(s) 206 are programmable hardware-based processors configured to execute software instructions, such as those used to define a software or computer program, stored to a computer-readable storage medium (such as memory 212), such as non-transitory computer-readable mediums including a storage device (e.g., a disk drive, or an optical drive) or a memory (such as Flash memory or RAM) or any other type of volatile or non-volatile memory, that stores instructions to cause the one or more processors 206 to perform the techniques described herein.

Memory 212 includes one or more devices configured to store programming modules and/or data associated with operation of access point 200. For example, memory 212 may include a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause the one or more processor(s) 206 to perform the techniques described herein.

In this example, memory 212 stores executable software including an application programming interface (API) 240, a communications manager 242, configuration settings 250, a device status log 252, data storage 254, log controller 255, and blackhole prevention engine 256. Device status log 252 includes a list of events specific to access point 200. The events may include a log of both normal events and error events such as, for example, memory status, reboot or restart events, crash events, cloud disconnect with self-recovery events, low link speed or link speed flapping events, Ethernet port status, Ethernet interface packet errors, upgrade failure events, firmware upgrade events, configuration changes, etc., as well as a time and date stamp for each event. Log controller 255 determines a logging level for the device based on instructions from NMS 130. Data 254 may store any data used and/or generated by access point 200, including data collected from UEs 148, such as data used to calculate one or more SLE metrics, that is transmitted by access point 200 for cloud-based management of wireless networks 106A by NMS 130.

Input/output (I/O) 210 represents physical hardware components that enable interaction with a user, such as buttons, a display, and the like. Although not shown, memory 212 typically stores executable software for controlling a user interface with respect to input received via I/O 210. Communications manager 242 includes program code that, when executed by processor(s) 206, allow access point 200 to communicate with UEs 148 and/or network(s) 134 via any of interface(s) 230 and/or 220A-220C. Configuration settings 250 include any device settings for access point 200 such as radio settings for each of wireless interface(s) 220A-220C. These settings may be configured manually or may be remotely monitored and managed by NMS 130 to optimize wireless network performance on a periodic (e.g., hourly or daily) basis.

AP device 200 may measure and report network data from status log 252 to NMS 130. The network data may comprise event data, telemetry data, and/or other SLE-related data. The network data may include various parameters indicative of the performance and/or status of the wireless network. The parameters may be measured and/or determined by one or more of the UE devices and/or by one or more of the APs in a wireless network. NMS 130 may determine one or more SLE metrics based on the SLE-related data received from the APs in the wireless network and store the SLE metrics as network data 137 (FIG. 1A).

In accordance with one or more aspects of the disclosure, AP 200 includes blackhole prevention engine 250 configured to determine, based on data from memory 212 or NMS 130, that network connectivity associated with a VLAN is down and disable access to one or more WLANs 106 that are associated with the VLAN. Blackhole prevention engine 256 is further described below in FIG. 2B.

FIG. 2B is a block diagram illustrating further details of blackhole prevention engine 256 of AP 200 of FIG. 2A, in accordance with one or more techniques of this disclosure. In the example of FIG. 2B, blackhole prevention engine 256 includes information collector 290, information analyzer 292, mapping engine 296, and action engine 297.

As described above, AP 200 may enable one or more clients to connect to WLAN 106. WLAN 106 may be associated with one or more VLANs that may manage and segment network traffic so that clients of WLAN 106 may receive specific network access and services and be logically isolated from clients associated with different VLANs. For WLAN 106 to provide wireless network services to clients, AP 200 may tag network traffic from clients with a VLAN identifier associated with a VLAN and forward the network traffic with the tagged VLAN identifier to a network device (e.g., switch 146), which may route the network traffic based on the VLAN identifier. In some examples, one or more tunneling sessions (e.g., tunneling session 127 of FIG. 1A) may be established to tunnel network traffic for a corresponding VLAN (e.g., VLAN 145 of FIG. 1A) through the tunneling sessions to a remote endpoint (e.g., a remote router for server 128A of FIG. 1A).

Information collector 290 may collect information associated with network connectivity of one or more VLANs. In some examples, information collector 290 may collect information obtained by AP 200 or from other NAS devices (e.g., switch 146A, router 147A, etc.), client devices (e.g., client devices 148), and/or from NMS 130. For instance, information collector 290 may obtain network data 137 (e.g., connectivity information 136) of NMS 130 and/or from memory 212 (e.g., status log 252, configuration/radio settings 250, etc.) of AP 200. In these instances, information collector 290 may collect information such as settings and configurations for one or more NAS devices and/or network data (e.g., event data, telemetry data, etc.).

In some examples, information collector 290 may collect information from NMS 130 that has been processed by NMS 130, such that the collected information may have been extracted from messages, counters, statistics, etc. Information collector 290 may periodically obtain information related to network connectivity associated with a VLAN (e.g., information collector 290 may request, receive, automatically request, and/or automatically receive, information related to network connectivity associated with a VLAN). For instance, NMS 130 may periodically send, or AP 200 may periodically receive, network data via information collector 290. In one example, NMS 130 may be aware of the one or more VLANs associated with AP 200 such that NMS 130 may only send network data that is relevant to the one or more VLANs associated with AP 200. In some examples, information collector 290 may store the collected information in a database or data structure.

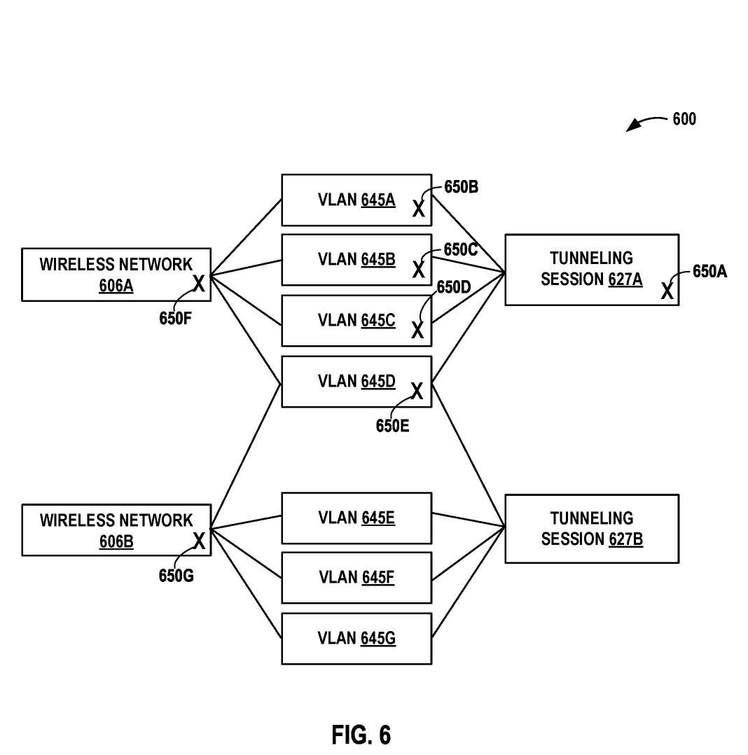

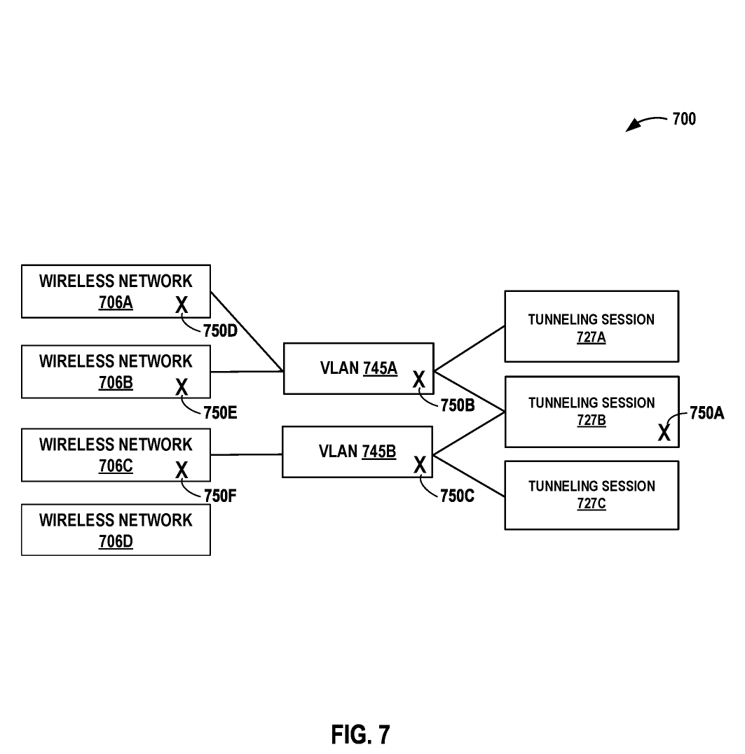

Mapping engine 296 may, based on information from information collector 290, generate a first mapping of one or more WLANs associated with one or more VLANs (referred to herein as WLAN-to-VLAN mapping) and a second mapping of the one or more VLANs associated with one or more tunneling sessions (referred to herein as VLAN-to-Tunnel mapping), as further illustrated in FIGS. 6 and 7. Each mapping may include one-to-one, one-to-many, many-to-one, and/or many-to-many relationships. For example, a WLAN may be mapped to one or more VLANs and a VLAN may be mapped to one or more WLANs. Similarly, a VLAN may be mapped to one or more tunneling sessions and a tunneling session may be mapped to one or more VLANs. Mapping engine 296 may integrate the WLAN-to-VLAN mapping with the VLAN-to-Tunnel mapping to generate a mapping of a wireless aspect of a network connectivity associated with a VLAN and a wired aspect of the network connectivity associated with the VLAN. For example, a WLAN-to-VLAN mapping with respect to FIG. 1A may include WLAN 106A mapped to VLAN 145 and may represent the wireless aspect of a network connectivity associated with VLAN 145, and a VLAN-to-Tunnel mapping with respect to FIG. 1A may include VLAN 145 mapped to tunneling session 127 and may represent a wired aspect of the network connectivity associated with VLAN 145.

While the example above describes mapping engine 296 generating a mapping of WLANs, VLANs, and tunneling sessions, in other examples, mapping engine 296 may obtain mappings from NMS 130. For instance, with respect to FIG. 1A, NMS 130 may generate a mapping of WLAN 106A to VLAN 145 and a mapping of VLAN 145 to tunneling session 127, and mapping engine 296 may obtain the mappings from NMS 130.

Information analyzer 292 may obtain information from information collector 290 and/or mapping engine 296 to determine whether network connectivity associated with a VLAN is down. In one example, network connectivity associated with a VLAN may be considered “down” when a client device is unable to send network traffic to a desired endpoint due to an issue associated with the VLAN.

In some examples, information analyzer 292 may determine whether a network connectivity associated with a VLAN is down based on determining whether there is an issue associated with the configuration of the VLAN. For example, information analyzer 292 may obtain configuration information from information collector 290. Based on this configuration information, information analyzer 292 may determine whether the network connectivity associated with a VLAN is down by determining whether a port of an associated AP or switch is misconfigured. For instance, in the example of FIG. 1A, information analyzer 292 may compare the configuration information of AP 142A-1 that specifies that VLAN 145 is supported by a port of switch 146A to the configuration information of switch 146A that specifies that the port of switch 146A supports a different VLAN. Based on this comparison, information analyzer 292 may determine that the network connectivity associated with VLAN 145 is down.

In some examples, information analyzer 292 may determine whether network connectivity associated with a VLAN is down based on determining whether there is an issue with a physical connection associated with the VLAN. For example, information analyzer 292 may determine whether there is an issue with a physical connection between an AP and a switch and/or a switch and a router. Information analyzer 292 may obtain information from information collector 290 that indicates a state (e.g., connected or not connected) of a physical connection. For instance, in the example of FIG. 1A, information analyzer 292 may obtain information that indicates the physical connection between AP 142A-1 and switch 146A is not connected (e.g., due to a loose, severed, or unplugged physical connection). Based on the information that indicates the physical connection between AP 142A-1 and switch 146A is not connected, information analyzer 292 may determine that the network connectivity associated with VLAN 145 is down.

In some examples, information analyzer 292 may determine whether network connectivity associated with a VLAN is down based on determining whether there is an issue with a tunnel associated with the VLAN. Information analyzer 292 may obtain information from information collector 290 that indicates a state (e.g., misconfigured or not misconfigured) of a tunnel. For instance, in the example of FIG. 1A, information analyzer 292 may obtain information that indicates tunnel 127 is misconfigured (e.g., due to an issue with a certificate associated with router 147A). Based on the information that indicates tunnel 127 is misconfigured, information analyzer 292 may determine that the network connectivity associated with VLAN 145 is down.

In some examples, information analyzer 292 may determine whether network connectivity associated with a VLAN is down based on determining that a number of active tunneling session associated with the VLAN is less than a number configured tunneling sessions associated with the VLAN. Information analyzer 292 may obtain information from information collector 290 that indicates the number of active tunneling sessions associated with the VLAN and the number configured tunneling sessions associated with the VLAN. For instance, in the example of FIG. 1A, information analyzer 292 may obtain information that indicates zero active tunneling sessions associated with VLAN 145 and one configured tunneling session 127 associated with VLAN 145. Based on determining that the number of active tunneling sessions (e.g., 0) does not match (e.g., is less than) a number of configured tunneling sessions (e.g., 1), information analyzer 292 may determine that network connectivity associated with VLAN 145 is down.

Based on determining that network connectivity associated with the VLAN is down, information analyzer 292 may determine one or more WLANs associated with the VLAN and disable access to the one or more WLANs. For example, based on determining an issue with tunneling session 127, information analyzer 292 may assign, or instruct mapping engine 296 to assign, a label or other identifier (e.g., a tag, a mark, a flag, etc.) to VLAN 145 associated with tunneling session 127 and/or assign a label or other identifier to WLAN 106A that is associated with VLAN 145 within the VLAN-to-Tunnel mapping and the WLAN-to-VLAN mapping.

Blackhole prevention engine 256 may include action engine 297 configured to perform one or more actions (e.g., disabling access to one or more WLANs associated with the VLAN) based on a determination that network connectivity associated with a VLAN is down. In some examples, action engine 297 may include access engine 298 configured to disable access to one or more WLANs based on labels or identifiers assigned to a WLAN within the one or more mappings. For instance, access engine 298 may disable access to WLAN 106A based on a mapping where WLAN 106A is tagged.

In one example, access engine 298 may disable access to WLAN 106A by disabling broadcasting of the service set identifier (herein, “SSID”) associated with WLAN 106A. By disabling broadcasting of the SSID for WLAN 106A, access engine 298 may prevent client devices from connecting to WLAN 106A or may forcibly disconnect client devices that are actively connected to WLAN 106A to connect to a different WLAN or to a different access point. In some examples, access engine 298 may disable access to WLAN 106A by configuring restrictions associated with the SSID associated with WLAN 106A. In one example, access engine 298 may deny a client device from connecting to WLAN 106A.

Action engine 297 may include solution engine 299 configured to determine and/or implement one or more remedial actions (e.g., work arounds, actions, fixes, etc.) to reinstate (e.g., fix) the network connectivity associated with a VLAN that is down. In one example, solution engine 299 may obtain configuration information of one or more network devices associated with VLAN 145 from information collector 290 and may reconfigure the one or more network devices associated with VLAN 145, such as reconfiguring ports of network devices associated with VLAN 145, reconfiguring tunneling configurations of network devices associated with tunneling session 127, rebooting/resetting the one or more network devices associated with VLAN 145, etc. In one example, solution engine 299 may generate a notification indicating a remedial action to remedy the network connectivity associated with the VLAN that is down. For example, solution engine 299 may generate a notification to reconnect the physical connection of network devices associated with VLAN 145 (e.g., network connection between AP 142A-1 and switch 146A), reconfigure ports of network devices associated with VLAN 145, reconfigure tunneling configurations of network devices associated with VLAN 145, reboot/reset the one or more network devices associated with VLAN 145, and/or any other notification to remedy the network connectivity associated with VLAN 145.

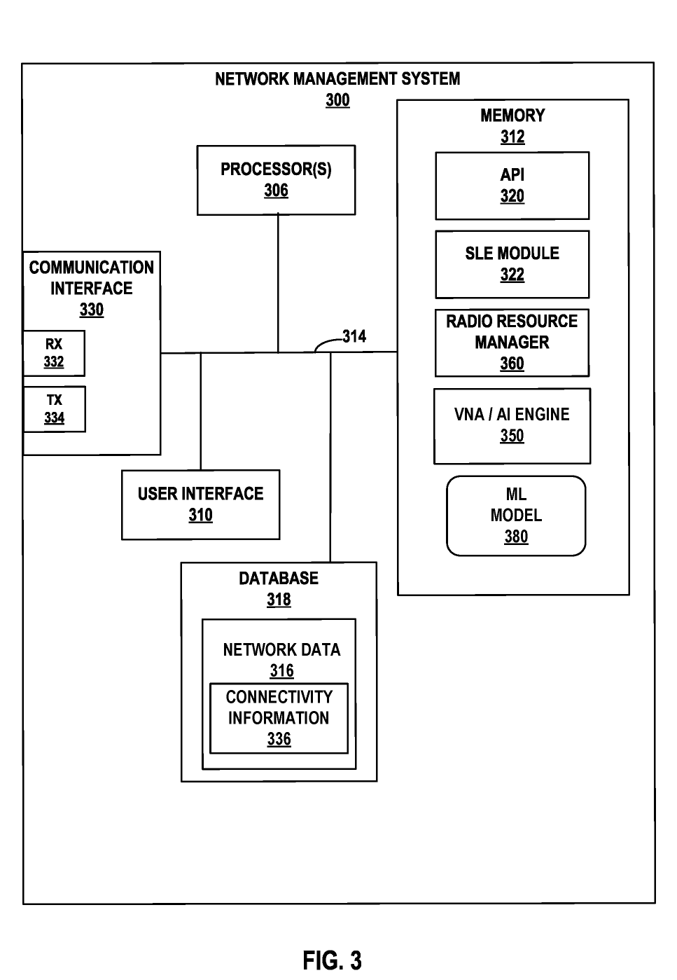

FIG. 3 is a block diagram of an example network management system (NMS) 300, in accordance with one or more techniques of the disclosure. NMS 300 may be used to implement, for example, NMS 130 in FIGS. 1A-1B. In such examples, NMS 300 is responsible for monitoring and management of one or more wireless networks 106A-106N at sites 102A-102N, respectively.

NMS 300 includes a communications interface 330, one or more processor(s) 306, a user interface 310, a memory 312, and a database 318. The various elements are coupled together via a bus 314 over which the various elements may exchange data and information. Database 318 may include network data 316 which includes connectivity information 336. In some examples, NMS 300 receives data from one or more of client devices 148, APs 142, switches 146 and other network nodes within network 134, e.g., routers 187 of FIG. 1B, which may be used to calculate one or more SLE metrics, update network data 316, and/or determine connectivity information 336. In some examples, connectivity information 336 may relate to a number of active tunneling sessions, a number of configured tunneling sessions, configuration information of a logical connection between NAS devices, a state of a physical or logical connection, or any other information associated with a connection with or through a NAS device. NMS 300 may analyze network data 316 for cloud-based management of wireless networks 106A-106N. In some examples, NMS 300 may be part of another server shown in FIG. 1A or a part of any other server.

Processor(s) 306 execute software instructions, such as those used to define a software or computer program, stored to a computer-readable storage medium (such as memory 312), such as non-transitory computer-readable mediums including a storage device (e.g., a disk drive, or an optical drive) or a memory (such as Flash memory or RAM) or any other type of volatile or non-volatile memory, that stores instructions to cause the one or more processors 306 to perform the techniques described herein.

Communications interface 330 may include, for example, an Ethernet interface. Communications interface 330 couples NMS 300 to a network and/or the Internet, such as any of network(s) 134 as shown in FIG. 1A, and/or any local area networks. Communications interface 330 includes a receiver 332 and a transmitter 334 by which NMS 300 receives/transmits data and information to/from any of client devices 148, APs 142, switches 146, servers 110, 116, 122, 128 and/or any other network nodes, devices, or systems forming part of network system 100 such as shown in FIG. 1A. In some scenarios described herein in which network system 100 includes “third-party” network devices that are owned and/or associated with different entities than NMS 300, NMS 300 does not receive, collect, or otherwise have access to network data from the third-party network devices.

The data and information received by NMS 300 may include, for example, telemetry data, SLE-related data, or event data received from one or more of client device APs 148, APs 142, switches 146, or other network nodes, e.g., routers 187 of FIG. 1B, used by NMS 300 to remotely monitor the performance of wireless networks 106A-106N and application sessions from client device to cloud-based application server. NMS 300 may further transmit data via communications interface 330 to any of network devices such as client devices 148, APs 142, switches 146, other network nodes within network 134, admin device 111 to remotely manage wireless networks 106A-106N and portions of the wired network.

Memory 312 includes one or more devices configured to store programming modules and/or data associated with operation of NMS 300. For example, memory 312 may include a computer-readable storage medium, such as a non-transitory computer-readable medium including a storage device (e.g., a disk drive, or an optical drive) or a memory (such as Flash memory or RAM) or any other type of volatile or non-volatile memory, that stores instructions to cause the one or more processor(s) 306 to perform the techniques described herein.

In this example, memory 312 includes an API 320, an SLE module 322, a virtual network assistant (VNA)/AI engine 350, and a radio resource management (RRM) engine 360. In accordance with the disclosed techniques, VNA/AI engine 350 may include a blackhole detection engine capable of performing the techniques of this disclosure. NMS 300 may also include any other programmed modules, software engines and/or interfaces configured for remote monitoring and management of wireless networks 106A-106N and portions of the wired network, including remote monitoring and management of any of APs 142/200, switches 146, or other network devices, e.g., routers 187 of FIG. 1B.

SLE module 322 enables set up and tracking of thresholds for SLE metrics for each network 106A-106N. SLE module 322 further analyzes SLE-related data collected by APs, such as any of APs 142 from UEs in each wireless network 106A-106N. For example, APs 142A-1- 142A-N collect SLE-related data from UEs 148A-1-148A-N currently connected to wireless network 106A. This data is transmitted to NMS 300, which executes by SLE module 322 to determine one or more SLE metrics for each UE 148A-1-148A-N currently connected to wireless network 106A. This data, in addition to any network data collected by one or more APs 142A-1-142A-N in wireless network 106A, is transmitted to NMS 300 and stored as, for example, network data 316 in database 318.

RRM engine 360 monitors one or more metrics for each site 102A-102N in order to learn and optimize the RF environment at each site. For example, RRM engine 360 may monitor the coverage and capacity SLE metrics for a wireless network 106 at a site 102 in order to identify potential issues with SLE coverage and/or capacity in the wireless network 106 and to make adjustments to the radio settings of the access points at each site to address the identified issues. For example, RRM engine may determine channel and transmit power distribution across all APs 142 in each network 106A-106N. For example, RRM engine 360 may monitor events, power, channel, bandwidth, and number of clients connected to each AP. RRM engine 360 may further automatically change or update configurations of one or more APs 142 at a site 102 with an aim to improve the coverage and capacity SLE metrics and thus to provide an improved wireless experience for the user.

VNA/AI engine 350 analyzes data received from network devices as well as its own data to identify when undesired to abnormal states are encountered at one of the network devices. For example, VNA/AI engine 350 may identify the root cause of any undesired or abnormal states, e.g., any poor SLE metric(s) indicative of connected issues at one or more network devices. In addition, VNA/AI engine 350 may automatically invoke one or more corrective actions intended to address the identified root cause(s) of one or more poor SLE metrics. Examples of corrective actions that may be automatically invoked by VNA/AI engine 350 may include, but are not limited to, invoking RRM 360 to reboot one or more APs, adjusting/modifying the transmit power of a specific radio in a specific AP, adding SSID configuration to a specific AP, changing channels on an AP or a set of APs, etc. The corrective actions may further include restarting a switch and/or a router, invoking downloading of new software to an AP, switch, or router, etc. These corrective actions are given for example purposes only, and the disclosure is not limited in this respect. If automatic corrective actions are not available or do not adequately resolve the root cause, VNA/AI engine 350 may proactively provide a notification including recommended corrective actions to be taken by IT personnel, e.g., a site or network administrator using admin device 111, to address the network error.

In some examples, ML model 380 may comprise a supervised ML model that is trained, using training data comprising pre-collected, labeled network data received from network devices (e.g., client devices, APs, switches and/or other network nodes). The supervised ML model may comprise one of a logistical regression, naïve Bayesian, support vector machine (SVM), or the like. In other examples, ML model 380 may comprise an unsupervised ML model. Although not shown in FIG. 3, in some examples, database 318 may store the training data and VNA/AI engine 350 or a dedicated training module may be configured to train ML model 380 based on the training data to determine appropriate weights across the one or more features of the training data.

In some examples, NMS 300 may perform one or more functions of blackhole prevention engine 256 of FIG. 2B. For example, NMS 300 may include a module or engine configured within memory 312 to execute the functionality of the techniques of this disclosure. In this way, the techniques of the present disclosure are described in this example as performed by an AP 200, by NMS 300, or a combination of AP 200 and NMS 300.

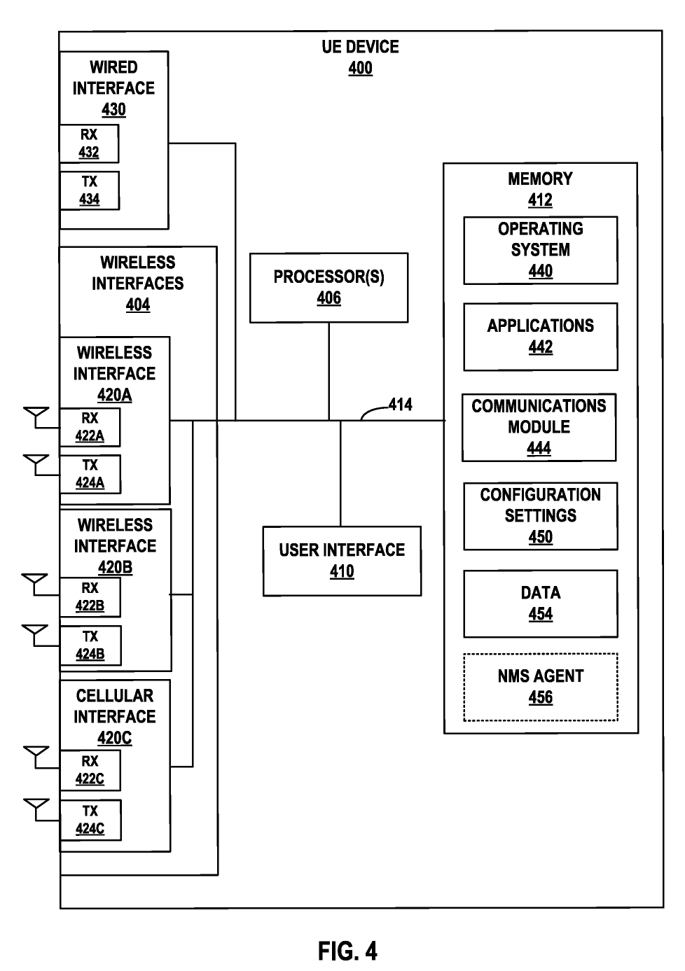

FIG. 4 shows an example user equipment (UE) device 400, in accordance with one or more techniques of this disclosure. Example UE device 400 shown in FIG. 4 may be used to implement any of UEs 148 as shown and described herein with respect to FIG. 1A. UE device 400 may include any type of wireless client device, and the disclosure is not limited in this respect. For example, UE device 400 may include a mobile device such as a smart phone, tablet or laptop computer, a personal digital assistant (PDA), a wireless terminal, a smart watch, a smart ring, or any other type of mobile or wearable device. In some examples, UE 400 may also include a wired client-side device, e.g., an IoT device such as a printer, a security sensor or device, an environmental sensor, or any other device connected to the wired network and configured to communicate over one or more wireless networks.

UE device 400 includes a wired interface 430, wireless interfaces 420A-420C, one or more processor(s) 406, memory 412, and a user interface 410. The various elements are coupled together via a bus 414 over which the various elements may exchange data and information. Wired interface 430 represents a physical network interface and includes a receiver 432 and a transmitter 434. Wired interface 430 may be used, if desired, to couple, either directly or indirectly, UE 400 to a wired network device, such as one of switches 146 of FIG. 1A, within the wired network via a cable, such as one of Ethernet cables 144 of FIG. 1A.

First, second, and third wireless interfaces 420A, 420B, and 420C include receivers 422A, 422B, and 422C, respectively, each including a receive antenna via which UE 400 may receive wireless signals from wireless communications devices, such as APs 142 of FIG. 1A, AP 200 of FIG. 2, other UEs 148, or other devices configured for wireless communication. First, second, and third wireless interfaces 420A, 420B, and 420C further include transmitters 424A, 424B, and 424C, respectively, each including transmit antennas via which UE 400 may transmit wireless signals to wireless communications devices, such as APs 142 of FIG. 1A, AP 200 of FIG. 2, other UEs 148 and/or other devices configured for wireless communication. In some examples, first wireless interface 420A may include a Wi-Fi 802.11 interface (e.g., 2.4 GHz and/or 5 GHz) and second wireless interface 420B may include a Bluetooth interface and/or a Bluetooth Low Energy interface. Third wireless interface 420C may include, for example, a cellular interface through which UE device 400 may connect to a cellular network.

Processor(s) 406 execute software instructions, such as those used to define a software or computer program, stored to a computer-readable storage medium (such as memory 412), such as non-transitory computer-readable mediums including a storage device (e.g., a disk drive, or an optical drive) or a memory (such as Flash memory or RAM) or any other type of volatile or non-volatile memory, that stores instructions to cause the one or more processors 406 to perform the techniques described herein.

Memory 412 includes one or more devices configured to store programming modules and/or data associated with operation of UE 400. For example, memory 412 may include a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause the one or more processor(s) 406 to perform the techniques described herein.

In this example, memory 412 includes an operating system 440, applications 442, a communications module 444, configuration settings 450, and data storage 454. Communications module 444 includes program code that, when executed by processor(s) 406, enables UE 400 to communicate using any of wired interface(s) 430, wireless interfaces 420A-420B and/or cellular interface 450C. Configuration settings 450 include any device settings for UE 400 settings for each of wireless interface(s) 420A-420B and/or cellular interface 420C.

Data storage 454 may include, for example, a status/error log including a list of events specific to UE 400. The events may include a log of both normal events and error events according to a logging level based on instructions from NMS 130. Data storage 454 may store any data used and/or generated by UE 400, such as data used to calculate one or more SLE metrics or identify relevant behavior data, that is collected by UE 400 and either transmitted directly to NMS 130 or transmitted to any of APs 142 in a wireless network 106 for further transmission to NMS 130.

As described herein, UE 400 may measure and report network data from data storage 454 to NMS 130. The network data may comprise event data, telemetry data, and/or other SLE-related data. The network data may include various parameters indicative of the performance and/or status of the wireless network. NMS 130 may determine one or more SLE metrics and store the SLE metrics as network data 137 (FIG. 1A) based on the SLE-related data received from the UEs or client devices in the wireless network.

Optionally, UE device 400 may include an NMS agent 456. NMS agent 456 is a software agent of NMS 130 that is installed on UE 400. In some examples, NMS agent 456 can be implemented as a software application running on UE 400. NMS agent 456 collects information including detailed client-device properties from UE 400, including insight into UE 400 roaming behaviors. The information provides insight into client roaming algorithms, because roaming is a client device decision. In some examples, NMS agent 456 may display the client-device properties on UE 400. NMS agent 456 sends the client device properties to NMS 130, via an AP device to which UE 400 is connected. NMS agent 456 can be integrated into a custom application or as part of location application. NMS agent 456 may be configured to recognize device connection types (e.g., cellular or Wi-Fi), along with the corresponding signal strength. For example, NMS agent 456 recognizes access point connections and their corresponding signal strengths. NMS agent 456 can store information specifying the APs recognized by UE 400 as well as their corresponding signal strengths. NMS agent 456 or other element of UE 400 also collects information about which APs the UE 400 connected with, which also indicates which APs the UE 400 did not connect with. NMS agent 456 of UE 400 sends this information to NMS 130 via its connected AP. In this manner, UE 400 sends information about not only the AP that UE 400 connected with, but also information about other APs that UE 400 recognized and did not connect with, and their signal strengths. The AP in turn forwards this information to the NMS, including the information about other APs the UE 400 recognized besides itself. This additional level of granularity enables NMS 130, and ultimately network administrators, to better determine the Wi-Fi experience directly from the client device’s perspective.

In some examples, NMS agent 456 further enriches the client device data leveraged in service levels. For example, NMS agent 456 may go beyond basic fingerprinting to provide supplemental details into properties such as device type, manufacturer, and different versions of operating systems. In the detailed client properties, the NMS 130 can display the Radio Hardware and Firmware information of UE 400 received from NMS client agent 456. The more details the NMS agent 456 can draw out, the better the VNA/AI engine gets at advanced device classification. The VNA/AI engine of the NMS 130 continually learns and becomes more accurate in its ability to distinguish between device-specific issues or broad device issues, such as specifically identifying that a particular OS version is affecting certain clients.

In some examples, NMS agent 456 may cause user interface 410 to display a prompt that prompts an end user of UE 400 to enable location permissions before NMS agent 456 is able to report the device’s location, client information, and network connection data to the NMS. NMS agent 456 will then start reporting connection data to the NMS along with location data. In this manner, the end user of the client device can control whether the NMS agent 456 is enabled to report client device information to the NMS.

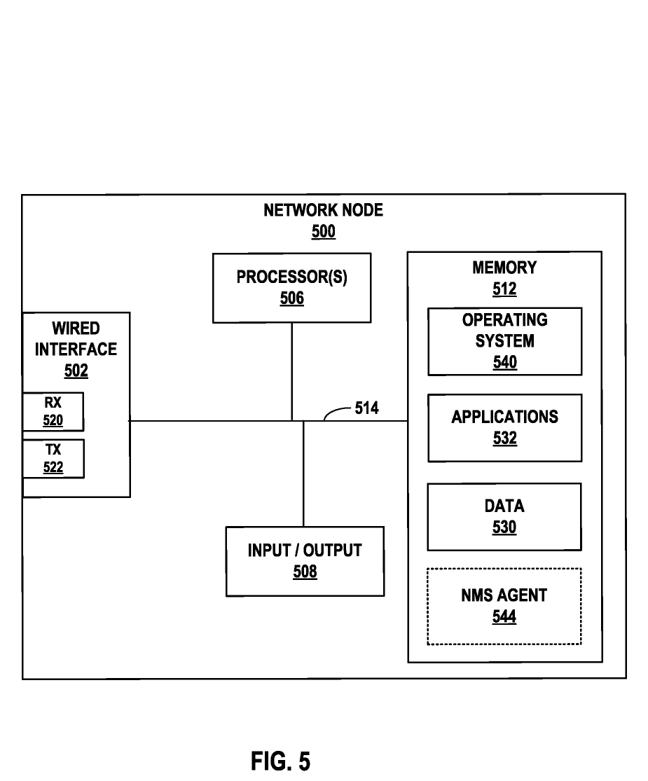

FIG. 5 is a block diagram illustrating an example network node 500, in accordance with one or more techniques of this disclosure. In one or more examples, the network node 500 implements a device or a server attached to the network 134 of FIG. 1A, e.g., switches 146, routers 147, AAA server 110, DHCP server 116, DNS server 122, web servers 128, etc., or another network device supporting one or more of wireless network 106, wired LAN 175, or SD-WAN 177, or data center 179 of FIG. 1B, e.g., routers 187.

In this example, network node 500 includes a wired interface 502, e.g., an Ethernet interface, a processor 506, input/output 508, e.g., display, buttons, keyboard, keypad, touch screen, mouse, etc., and a memory 512 coupled together via a bus 514 over which the various elements may interchange data and information. Wired interface 502 couples the network node 500 to a network, such as an enterprise network. Though only one interface is shown by way of example, network nodes may, and usually do, have multiple communication interfaces and/or multiple communication interface ports. Wired interface 502 includes a receiver 520 and a transmitter 522.

Memory 512 stores executable software applications 532, operating system 540 and data/information 530. Data 530 may include a system log and/or an error log that stores event data, including behavior data, for network node 500. In examples where network node 500 comprises a “third-party” network device, the same entity does not own or have access to both the APs or wired client-side devices and network node 500. As such, in the example where network node 500 is a third-party network device, NMS 130 does not receive, collect, or otherwise have access to the network data from network node 500.

In examples where network node 500 comprises a server, network node 500 may receive data and information, e.g., including operation related information, e.g., registration request, AAA services, DHCP requests, Simple Notification Service (SNS) look-ups, and Web page requests via receiver 520, and send data and information, e.g., including configuration information, authentication information, web page data, etc. via transmitter 522.

In examples where network node 500 comprises a wired network device, network node 500 may be connected via wired interface 502 to one or more APs or other wired client-side devices, e.g., IoT devices. For example, network node 500 may include multiple wired interfaces 502 and/or wired interface 502 may include multiple physical ports to connect to multiple APs or the other wired-client-side devices within a site via respective Ethernet cables. In some examples, each of the APs or other wired client-side devices connected to network node 500 may access the wired network via wired interface 502 of network node 500. In some examples, one or more of the APs or other wired client-side devices connected to network node 500 may each draw power from network node 500 via the respective Ethernet cable and a Power over Ethernet (PoE) port of wired interface 502.

In examples where network node 500 comprises a session-based router that employs a stateful, session-based routing scheme, network node 500 may be configured to independently perform path selection and traffic engineering. The use of session-based routing may enable network node 500 to eschew the use of a centralized controller, such as an SDN controller, to perform path selection and traffic engineering, and eschew the use of tunnels. In some examples, network node 500 may implement session-based routing as Secure Vector Routing (SVR), provided by Juniper Networks, Inc. In the case where network node 500 comprises a session-based router operating as a network gateway for a site of an enterprise network (e.g., router 187A of FIG. 1B), network node 500 may establish multiple peer paths (e.g., logical path 189 of FIG. 1B) over an underlying physical WAN (e.g., SD-WAN 177 of FIG. 1B) with one or more other session-based routers operating as network gateways for other sites of the enterprise network (e.g., router 187B of FIG. 1B). Network node 500, operating as a session-based router, may collect data at a peer path level, and report the peer path data to NMS 130.

In examples where network node 500 comprises a packet-based router, network node 500 may employ a packet- or flow-based routing scheme to forward packets according to defined network paths, e.g., established by a centralized controller that performs path selection and traffic engineering. In the case where network node 500 comprises a packet-based router operating as a network gateway for a site of an enterprise network (e.g., router 187A of FIG. 1B), network node 500 may establish multiple tunnels (e.g., logical path 189 of FIG. 1B) over an underlying physical WAN (e.g., SD-WAN 177 of FIG. 1B) with one or more other packet-based routers operating as network gateways for other sites of the enterprise network (e.g., router 187B of FIG. 1B). Network node 500, operating as a packet-based router, may collect data at a tunnel level, and the tunnel data may be retrieved by NMS 130 via an API or an open configuration protocol or the tunnel data may be reported to NMS 130 by NMS agent 544 or other module running on network node 500.

The data collected and reported by network node 500 may include periodically-reported data and event-driven data. Network node 500 is configured to collect logical path statistics via bidirectional forwarding detection (BFD) probing and data extracted from messages and/or counters at the logical path (e.g., peer path or tunnel) level. In some examples, network node 500 is configured to collect statistics and/or sample other data according to a first periodic interval, e.g., every 3 seconds, every 5 seconds, etc. Network node 500 may store the collected and sampled data as path data, e.g., in a buffer.

In some examples, network node 500 optionally includes an NMS agent 544. NMS agent 544 may periodically create a package of the statistical data according to a second periodic interval, e.g., every 3 minutes. The collected and sampled data periodically-reported in the package of statistical data may be referred to herein as “oc-stats.” In some examples, the package of statistical data may also include details about clients connected to network node 500 and the associated client sessions. NMS agent 544 may then report the package of statistical data to NMS 130 in the cloud. In other examples, NMS 130 may request, retrieve, or otherwise receive the package of statistical data from network node 500 via an API, an open configuration protocol, or another of communication protocols. The package of statistical data created by NMS agent 544 or another module of network node 500 may include a header identifying network node 500 and the statistics and data samples for each of the logical paths from network node 500. In still other examples, NMS agent 544 reports event data to NMS 130 in the cloud in response to the occurrence of certain events at network node 500 as the events happen. The event-driven data may be referred to herein as “oc-events.”

FIG. 6 illustrates an example operation of blackhole prevention, in accordance with one or more techniques of the disclosure. FIG. 6 includes an example mapping 600 including WLAN-to-VLAN mappings between WLANs 606 and VLANs 645 and VLAN-to-tunnel mappings between VLANs 645 and tunneling sessions 627.

In one example, mapping engine 296 of blackhole prevention engine 256 of FIG. 2B may generate the mappings illustrated by FIG. 6. In the WLAN-to-VLAN mappings, WLAN 606A may be associated with VLANs 645A–645D and WLAN 606B may be associated with VLANs 645D–645G. In the VLAN-to-tunnel mappings, VLANs 645A-645D may be associated with tunneling session 627A and VLANs 645D-645G may be associated with tunneling session 627B, where VLAN 645D is associated with WLAN 606A and WLAN 606B and tunneling sessions 627A and 627B. The association between WLAN 606A, VLAN 645A, and tunneling session 627A may be an example of the association between WLAN 106A, VLAN 145, and tunneling session 127 of FIG. 1A.

In one example, information analyzer 292 may determine whether network connectivity associated with one or more of VLANs 645A–645G is down and determine one or more WLANs 606 that are associated with a VLAN that is down. For instance, information analyzer 292 may determine that there is an issue with tunneling session 627A such that tunneling session 627A may be down. Information analyzer 292 may assign a label 650A (e.g., tag, mark, flag, etc.) within mapping 600 indicating that tunneling session 627A is down. Information analyzer 292, based on determining that tunneling session 627A may be down, may use the VLAN-to-tunnel mappings to determine which of VLANs 645A–645D are associated with tunneling session 627A. In this example, information analyzer 292 may determine that VLANs 645A–645D are associated with tunneling session 627A and may assign labels 650B–650E to indicate that the network connectivity associated with VLANs 645A–645D is down.

Information analyzer 292 may use the WLAN-to-VLAN mappings to determine which of WLANs 606 are associated with VLANs 645A–645D. For instance, information analyzer 292 may use the WLAN-to-VLAN mappings to determine that WLAN 606A is associated with VLANs 645A–645D and WLAN 606B is associated with VLAN 645D. Information analyzer 292 may assign label 650F to WLAN 606A and label 650G to WLAN 606B to indicate that WLANs 606A and 606B may have issues with network connectivity associated with VLANs 645A–645D.

As described above, action engine 297 may perform an action based on labels 650A–650G, such as disabling access to WLANs 606A and 606B based on labels 650F and 650G assigned to WLANs 606A and 606B, respectively.

FIG. 7 illustrates another example operation of blackhole prevention, in accordance with one or more techniques of the disclosure. FIG. 7 includes an example mapping 700 with WLAN-to-VLAN mappings between WLANs 706 and VLANs 745 and VLAN-to-tunnel mappings between VLANs 745 and tunneling sessions 727.

In one example, mapping engine 296 of blackhole prevention engine 256 of FIG. 2B may generate the mappings illustrated by FIG. 7. In the WLAN-to-VLAN mappings, WLAN 706A may be associated with VLAN 745A, WLAN 706B may be associated with VLAN 745A, WLAN 706C may be associated with VLAN 745B, and WLAN 706D may be associated with no VLAN. In the VLAN-to-tunnel mappings, VLAN 745A may be associated with tunneling sessions 727A and 727B, and VLAN 745B may be associated with tunneling sessions 727B and 727C.

In one example, information analyzer 292 may determine whether there is an issue with a tunneling session 727 and determine one or more WLANs 706 corresponding to one or more VLANs 745 that are associated with tunneling session 727B. For instance, information analyzer 282 may determine that there is an issue with tunneling session 727B such that tunneling session 727B may be down. Information analyzer 292 may assign a label 750A (e.g., tag, mark, flag, etc.) within mapping 700 indicating that tunneling session 727B is down. Information analyzer 292, based on determining that tunneling session 727B may be down, may use the VLAN-to-tunnel mappings to determine which of VLANs 745A–745B are associated with tunneling session 727B. In this example, information analyzer 292 may determine that VLANs 745A–745B are associated with tunneling session 727B and may assign labels 750B–750C to indicate that the network connectivity associated with VLANs 745A–745B is down.

In some examples, information analyzer 292 may use the WLAN-to-VLAN mappings to determine which of WLANs 706 are associated with VLANs 745A–745B. For instance, information analyzer 292 may use the WLAN-to-VLAN mappings to determine that WLANs 706A–706B are associated with VLAN 745A, WLAN 706C is associated with VLAN 745B, and WLAN 706D is associated with none of VLANs 745A-745B. In this example, for VLAN 745A to be without issue, both of tunneling sessions 727A and 727B needs to be active. Based on determining that at least one of tunneling sessions 727 is down (e.g., tunneling session 727B), information analyzer 292 may assign label 750D to WLAN 706A, label 750E to WLAN 706B, and label 750F to WLAN 706C to indicate that WLANs 706A–706C may have issues with network connectivity associated with VLANs 745A–745B.

As described above, action engine 297 may perform an action based on labels 750A–750F, such as disabling access to WLANs 706A–706C based on labels 750D, 750E, and 750F assigned to WLANs 706A, 706B, and 706C, respectively.

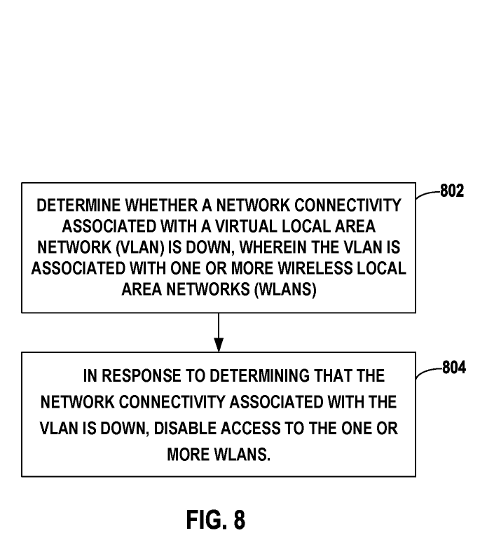

FIG. 8 is a flow chart illustrating an example operation for blackhole prevention, in accordance with one or more techniques of this disclosure. FIG. 8 is described with respect to AP 200 and blackhole prevention engine 256 of FIGS. 2A and 2B.

Blackhole prevention engine 256 may determine whether network connectivity associated with a VLAN is down (802). The VLAN may be associated with one or more WLANs. In some examples, to determine whether network connectivity associated with the VLAN is down, blackhole prevention engine 256 may determine that one or more tunneling sessions associated with the VLAN are down. Blackhole prevention engine 256 may determine that one or more tunneling sessions associated with the VLAN are down by comparing a set of configured tunneling sessions to a set of active tunneling sessions associated with the VLAN. If a number of the set of configured tunneling sessions is greater than a number of the set of active tunneling sessions, then blackhole prevention engine 256 may determine that the network connectivity associated with the VLAN is down.

In some examples, to determine whether network connectivity associated with a plurality of VLANs is down, blackhole prevention engine 256 may compare a set of configured tunneling sessions to a set of active tunneling sessions associated with the plurality of VLANs. Blackhole prevention engine 256 may identify one or more tunneling sessions from the set of configured tunneling sessions that are not included in the set of active tunneling sessions. Blackhole prevention engine 256 may identify the one or more VLANs associated with the identified one or more tunneling sessions and may determine that the network connectivity associated with the one more identified VLANs is down.

In some examples, to determine whether network connectivity associated with the VLAN is down, blackhole prevention engine 256 may determine whether there is an issue with one or more network devices associated with the VLAN. For instance, blackhole prevention engine 256 may determine whether there is an issue with AP 200. An issue with one or more network devices associated with the VLAN may include an issue associated with one or more of a configuration setting of the one or more network devices associated with the VLAN, a port of the one or more network devices associated with the VLAN, or a physical connection of the one or more network devices associated with the VLAN.

In some examples, to determine whether network connectivity associated with the VLAN is down, blackhole prevention engine 256 may determine whether there is an issue with a connection to a router associated with the VLAN. An issue with the connection to the router may be associated with the network device missing an IP address of the router. In one example, the router may be a gateway device.

In response to determining that the network connectivity associated with the VLAN is down, blackhole prevention engine 256 may disable access to one or more WLANs that are associated with the VLAN (804). In one example, disabling access to the one or more WLANs prevents one or more clients from viewing the availability of one or more WLANs. For instance, if access to a WLAN has been disabled, the WLAN may not appear on a client device’s list of accessible WLANs.

In one example, one or more client devices may be currently accessing a WLAN and blackhole prevention engine 256 may disable access to that WLAN (e.g., the one or more client devices may be disconnected from the WLAN). In one example, disabling access to one or more WLANs may cause one or more client devices to access to a different one or more WLANs.

In one example, one or more WLANs may be associated with a primary cluster of devices and a secondary cluster of devices. For instance, access to the one or more WLANs may be based on the primary cluster of devices. In this instance, blackhole prevention engine 256 may disable access to the one or more WLANs and then reenable access to the one or more WLANs such that reenabled access to the one or more WLANs is based on the secondary cluster of devices.

In one example, blackhole prevention engine 256 may notify, based on determining that the network connectivity associated with a VLAN is down, one or more client devices and/or administrators. The notification may include a solution to reinstate the network connectivity associated with the VLAN, an error indicating the cause of the network connectivity associated with the VLAN being down, a warning relating to blackholes, etc.

The techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such as a processor or an integrated circuit device, such as an integrated circuit chip or chipset. Alternatively or additionally, if implemented in software or firmware, the techniques may be realized at least in part by a computer-readable data storage medium comprising instructions that, when executed, cause a processor to perform one or more of the methods described above. For example, the computer-readable data storage medium may store such instructions for execution by a processor.

A computer-readable medium may form part of a computer program product, which may include packaging materials. A computer-readable medium may comprise a computer data storage medium such as random access memory (RAM), read-only memory (ROM), non-volatile random access memory (NVRAM), electrically erasable programmable read-only memory (EEPROM), Flash memory, magnetic or optical data storage media, and the like. In some examples, an article of manufacture may comprise one or more computer-readable storage media.

In some examples, the computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

The code or instructions may be software and/or firmware executed by processing circuitry including one or more processors, such as one or more digital signal processors (DSPs), general purpose microprocessors, application-specific integrated circuits (ASICs), field-programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, functionality described in this disclosure may be provided within software modules or hardware modules.

What is claimed is:

1. A network device comprising:
memory; and
one or more processors coupled to the memory, the one or more processors configured to:
determine whether a network connectivity associated with a virtual local area network (VLAN) is down, wherein the VLAN is associated with one or more wireless local area networks (WLANs); and
in response to determining that the network connectivity associated with the VLAN is down, disable access to the one or more WLANs.

2. The network device of claim 1, wherein to determine whether the network connectivity associated with the VLAN is down, the one or more processors are further configured to:
determine that one or more tunneling sessions associated with the VLAN are down.

3. The network device of claim 2, wherein to determine that the one or more tunneling sessions associated with the VLAN are down, the one or more processors are further configured to:
compare a set of configured tunneling sessions to a set of active tunneling sessions associated with the VLAN.

4. The network device of claim 3, wherein the one or more processors are further configured to:
determine, based on the comparison, that a number of the set of configured tunneling sessions is greater than a number of the set of active tunneling sessions; and
based on determining that the number of the set of configured tunneling sessions is greater than the number of the set of active tunneling sessions, disable access to the one or more WLANs associated with the VLAN.

5. The network device of claim 1, wherein to determine whether the network connectivity associated with the VLAN is down, the one or more processors are further configured to:
determine whether there is an issue with one or more network devices associated with the VLAN, wherein the one or more network devices associated with the VLAN include the network device.

6. The network device of claim 5, wherein to determine whether there is an issue with the one or more network devices associated with the VLAN, the one or more processors are configured to:
determine whether there is an issue associated with one or more of a configuration setting of the one or more network devices associated with the VLAN, a port of the one or more network devices associated with the VLAN, or a physical connection of the one or more network devices associated with the VLAN.

7. The network device of claim 1, wherein to determine whether the network connectivity associated with the VLAN is down, the one or more processors are configured to:
determine whether there is an issue with a connection to a router, wherein the router is associated with the VLAN.

8. The network device of claim 7, wherein to determine whether there is an issue with the connection to the router, the one or more processors are configured to:
determine whether the network device is missing an IP address of the router.

9. The network device of claim 1, wherein the one or more WLANs are associated with a primary cluster of devices and a secondary cluster of devices, and wherein access to the one or more WLANs is based on the primary cluster of devices.

10. The network device of claim 9, wherein the one or more processors are further configured to:
in response to disabling access to the one or more WLANs, reenable access to the one or more WLANs, wherein the reenabled access to the one or more WLANs is based on the secondary cluster of devices.

11. The network device of claim 1, wherein disabling access to the one or more WLANs prevents one or more clients from viewing the one or more WLANs.

12. A method comprising:
determining whether a network connectivity associated with a virtual local area network (VLAN) is down, wherein the VLAN is associated with one or more wireless local area networks (WLANs); and
in response to determining that the network connectivity associated with the VLAN is down, disabling access to the one or more WLANs.

13. The method of claim 12, wherein determining whether the network connectivity associated with the VLAN is down comprises:
determining that one or more tunneling sessions associated with the VLAN are down.

14. The method of claim 13, wherein determining that the one or more tunneling sessions associated with the VLAN are down comprises:
comparing a set of configured tunneling sessions to a set of active tunneling sessions associated with the VLAN.

15. The method of claim 14, further comprising:
determine, based on the comparison, that a number of the set of configured tunneling sessions is greater than a number of the set of active tunneling sessions; and
based on determining that the number of the set of configured tunneling sessions is greater than the number of the set of active tunneling sessions, disabling access to the one or more WLANs associated with the VLAN.

16. The method of claim 12, wherein determining whether the network connectivity associated with the VLAN is down further comprises:
determining whether there is an issue with one or more network devices associated with the VLAN, wherein the one or more network devices associated with the VLAN include the network device.

17. The method of claim 16, wherein determining whether there is an issue with the one or more network devices associated with the VLAN further comprises:
determining whether there is an issue associated with one or more of a configuration setting of the one or more network devices associated with the VLAN, a port of the one or more network devices associated with the VLAN, or a physical connection of the one or more network devices associated with the VLAN.

18. The method of claim 12, wherein determining whether the network connectivity associated with the VLAN is down further comprises:
determining whether there is an issue with a connection to a router, wherein the router is associated with the VLAN.

19. The method of claim 18, wherein determining whether there is an issue with the connection to the router further comprises:
determining whether a network device is missing an IP address of the router.

20. Non-transitory computer-readable storage media comprising instructions that, when executed by processing circuitry, cause the processing circuitry to:
determine whether a network connectivity associated with a virtual local area network (VLAN) is down, wherein the VLAN is associated with one or more wireless local area networks (WLANs); and
in response to determining that the network connectivity associated with the VLAN is down, disable access to the one or more WLANs.
